(19) United States
(12) Patent Application Publication
(10) Pub. No.: US 2022/0392017 A1
(43) Pub. Date: Dec. 8, 2022

(54) IMAGE PROCESSING FOR STANDARDIZING SIZE AND SHAPE OF ORGANISMS

(71) Applicant: President and Fellows of Harvard College, Cambridge, MA (US)

(72) Inventors: Sandeep Robert Datta, Cambridge, MA (US); Winthrop Gillis, Cambridge, MA (US); Jeffrey Evan, Cambridge, MA (US)

(73) Assignee: President and Fellows of Harvard College, Cambridge, MA (US)

(21) Appl. No.: 17/773,000

(22) PCT Filed: Oct. 30, 2020
(86) PCT No.: PCT/US2020/058273

§ 371 Date: Apr. 28, 2022

Related U.S. Application Data
(60) Provisional application No. 62/928,807, filed on Oct. 31, 2019.

(51) Int. Cl. G06T 3/40; H04N 5/232; G06T 7/593; G06T 5/00; G06T 3/60; G06T 7/194

(52) U.S. Cl. CPC G06T 3/4046; H04N 5/23222; H04N 5/23229; G06T 7/593; G06T 5/002; G06T 3/60; G06T 7/194; G06T 2207/10028; G06T 2207/20081; G06T 2207/20084; G06T 2207/20182

(57) ABSTRACT

Systems and methods are disclosed to manipulate or normalize image of animals to a reference size and shape. Synthetically normalizing the image data to a reference size and shape allows machine learning models to automatically identify subject behaviors in a manner that is robust to changes in the size and shape of the subject. The systems and methods of the invention can be applied to drug or gene therapy classification, drug or gene therapy screening, disease study including early detection of the onset of a disease, toxicology research, side-effect study, learning and memory process study, anxiety study, and analysis in consumer behavior.

### CROSS-REFERENCE TO RELATED APPLICATIONS

This application claims benefit under 35 U.S.C. § 119(e) of U.S. Provisional Application No. 62/928,807 filed Oct. 31, 2019, the contents of which are incorporated herein by reference in their entirety.

### FIELD

The present invention is directed to systems and methods for identifying and classifying animal behavior, human behavior, or other behavioral metrics.

### BACKGROUND

The following description includes information that may be useful in understanding the present invention. It is not an admission that any of the information provided herein is prior art or relevant to the presently claimed invention, or that any publication specifically or implicitly referenced is prior art.

The quantification of animal behavior is an essential first step in a range of biological studies, from drug discovery to understanding neurodegenerative disorders. It is usually performed by hand; a trained observer watches an animal behave, either live or on video or image, and records the timing of all relevant behaviors.

Behavioral data for a single experiment can include hundreds of mice, spanning thousands of hours of video, necessitating a team of observers, which inevitably decreases the reliability and reproducibility of results. In addition, what constitutes a “relevant behavior” is essentially left to the human observer: while it is trivial for a human observer to assign an anthropomorphic designation to a particular behavior or series of behaviors (i.e., “rearing,” “sniffing,” “investigating,” “walking,” “freezing,” “eating,” and the like), there are almost certainly behavioral states generated by the mouse that are relevant to the mouse that defy simple human categorization.

In more advanced applications, video and images can be semi-automatically analyzed by a computer program. However, the brain generates behaviors that unfold smoothly over time and yet are composed of distinct patterns of motion. Individual sensory neurons that trigger action can perform behaviorally-relevant computations in as little as a millisecond, and neural populations that mediate behavior exhibit dynamics that evolve on timescales of 10s to 100s of milliseconds [1-8]. This fast neural activity interacts with slower neuromodulator systems to generate behaviors that are organized at multiple timescales simultaneously [9]. Ultimately understanding how neural circuits create complex behaviors—particularly spontaneous or innate behaviors expressed by freely-behaving animals—requires a clear framework for characterizing how behavior is organized at the timescales relevant to the nervous system.

### SUMMARY

According to some aspects of the present disclosure, an image processing system is provided for standardizing the size and shape of organisms. The system includes a camera, a memory and a control system. The camera is configured to output images of a subject. The memory is in communication with the camera containing a machine readable medium. The machine readable medium includes stored machine executable code. The control system includes one or more processors coupled to the memory. The control system is configured to execute the machine executable code to cause the control system to receive a set of images of the subject from the camera and process the set of three-dimensional images with a model to normalize them to a reference size and shape to output a set of normalized images.

According to further aspects, an image processing system is provided for standardizing the size and shape of organisms. The control system camera is a three-dimensional camera and the set of images of the subject are depth images. The set of three-dimensional images may include images generated by imputation from two-dimensional cameras.

According to further aspects, an image processing system is provided for standardizing the size and shape of organisms. The control system model is a deep neural network. The control system model may be instantiated as an autoencoder, a convolutional autoencoder, a denoising convolutional autoencoder, a densenet, a generative adversarial network (GAN), a fully convolutional network (FCN) or a U-NET. The deep neural network was trained by first manipulating a size and shape of one or more training subjects in a set of training images. First manipulating the size and shape includes altering the position, rotation, length, width, height, and aspect ratio the organism. After the size and shape are altered, noise can then be added to the depth pixels to account for low-signal-to-noise imaging conditions. The resulting output is a manipulated set of training images and training the deep neural network to process the set of manipulated training images to the original matching image from the set of training images. The resulting output is a restored set of images wherein the training subject is the original size and shape from the set of training images.

According to further aspects, an image processing system is provided for standardizing the size and shape of organisms. The control system is further configured to process the set of normalized images using a computational model to partition the frames into at least one set of frames that represent modules and at least one set frames that represent transitions between the modules and store the at least one set of frames that represent modules referenced to a data identifier that represents a type of animal behavior.

According to further aspects, an image processing system is provided for standardizing the size and shape of organisms. The control system is further configured to pre-process the set of normalized images to isolate the subject from the background; identify an orientation of a feature of the subject on a set of frames of the video data with respect to a coordinate system common to each frame; modify the orientation of the subject in at least a subset of the set of frames so that the feature is oriented in the same direction with respect to the coordinate system to output a set of aligned frames; and process the set of aligned frames using a principal component analysis to output pose dynamics data for each frame of the set of aligned frames, wherein the pose dynamics data represents a pose of the subject for each aligned frame through principal component space.

According to some aspects of the present disclosure, a method is provided for standardizing the size and shape of organisms. The method includes receiving a set of images from a subject from a camera and processing the set of three-dimensional images with a model to normalize them to a reference size and shape to put a set of normalized images. The camera includes a three-dimensional camera and the set of images of the subject are depth images. The set of three-dimensional images may include images generated by imputation from two-dimensional cameras.

According to further aspects, a method is provided for standardizing the size and shape of organisms. The method model is a deep neural network. The control system model may be an autoencoder, a convolutional autoencoder, a denoising convolutional autoencoder, a densenet, a generative adversarial network (GAN), a fully convolutional network (FCN) or a U-NET. The deep neural network was trained by first manipulating a size and shape of a training subject in a set of training images. First manipulating the size and shape includes altering the position, rotation, length, width, height, and aspect ratio the organism. After the size and shape are altered, noise can then be added to the depth pixels to account for low-signal-to-noise imaging conditions. The resulting output is a manipulated set of training images and training the deep neural network to process the set of manipulated training images to the original matching image from the set of training images. The resulting output is a restored set of images wherein the training subject is the original size and shape from the set of training images.

According to further aspects, a method is provided for standardizing the size and shape of organisms. The method is further configured to include processing the set of normalized images using a computational model to partition the frames into at least one set of frames that represent modules and at least one set frames that represent transitions between the modules and storing the at least one set of frames that represent modules referenced to a data identifier that represents a type of animal behavior.

According to further aspects, a method is provided for standardizing the size and shape of organisms. The method is further configured to include pre-processing the set of normalized images to isolate the subject from the background; identifying an orientation of a feature of the subject on a set of frames of the video data with respect to a coordinate system common to each frame; modifying the orientation of the subject in at least a subset of the set of frames so that the feature is oriented in the same direction with respect to the coordinate system to output a set of aligned frames; and processing the set of aligned frames using a principal component analysis to output pose dynamics data for each frame of the set of aligned frames, wherein the pose dynamics data represents a pose of the subject for each aligned frame through principal component space.

According to some aspects of the present disclosure, a non-transitory machine readable medium is provided for standardizing the size and shape of organisms. The machine readable medium is configured to receive a set of images of the subject from a camera and process the set of three-dimensional images with a model to normalize them to a reference size and shape to output a set of normalized images. The camera includes a three-dimensional camera and the set of images of the subject are depth images. The set of three-dimensional images may include images generated by imputation from two-dimensional cameras.

According to some aspects of the present disclosure, a non-transitory machine readable medium is provided for standardizing the size and shape of organisms. The machine readable medium model is a deep neural network. The control system model may be an autoencoder, a convolutional autoencoder, a denoising convolutional autoencoder, a densenet, a generative adversarial network (GAN), a fully convolutional network (FCN) or a U-NET. The deep neural network was trained by first manipulating a size and shape of a training subject in a set of training images. First manipulating the size and shape includes altering the position, rotation, length, width, height, and aspect ratio the organism. After the size and shape are altered, noise can then be added to the depth pixels to account for low-signal-to-noise imaging conditions. The resulting output is a manipulated set of training images and training the deep neural network to process the set of manipulated training images to the original matching image from the set of training images. The resulting output is a restored set of images wherein the training subject is the original size and shape from the set of training images.

According to some aspects of the present disclosure, a non-transitory machine readable medium is provided for standardizing the size and shape of organisms. The machine readable medium is further configured to process the set of normalized images using a computational model to partition the frames into at least one set of frames that represent modules and at least one set frames that represent transitions between the modules and store the at least one set of frames that represent modules referenced to a data identifier that represents a type of animal behavior.

According to some aspects of the present disclosure, a non-transitory machine readable medium is provided for standardizing the size and shape of organisms. The machine readable medium is configured to pre-process the set of normalized images to isolate the subject from the background; identify an orientation of a feature of the subject on a set of frames of the video data with respect to a coordinate system common to each frame; modify the orientation of the subject in at least a subset of the set of frames so that the feature is oriented in the same direction with respect to the coordinate system to output a set of aligned frames; and process the set of aligned frames using a principal component analysis to output pose dynamics data for each frame of the set of aligned frames, wherein the pose dynamics data represents a pose of the subject for each aligned frame through principal component space.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 depicts, in accordance with various embodiments of the present invention, a diagram of a system designed to capture images of an animal;

FIG. 2 depicts, in accordance with various embodiments of the present invention, a flow chart showing processing steps performed on images;

FIG. 3 depicts, in accordance with various embodiments of the present invention, a set of images upon which a training procedure is performed;

FIGS. 4A and 4B depicts, in accordance with various embodiments of the present invention, a graph of behavioral classification; and

FIGS. 5A and 5B depicts, in accordance with various embodiments of the present invention, a graph of mouse shape and size.

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

### DETAILED DESCRIPTION

Unless defined otherwise, technical and scientific terms used herein have the same meaning as commonly understood by one of ordinary skill in the art to which this invention belongs. Szycher's Dictionary of Medical Devices CRC Press, 1995, may provide useful guidance to many of the terms and phrases used herein. One skilled in the art will recognize many methods and materials similar or equivalent to those described herein, which could be used in the practice of the present invention. Indeed, the present invention is in no way limited to the methods and materials specifically described.

In some embodiments, properties such as dimensions, shapes, relative positions, and so forth, used to describe and claim certain embodiments of the invention are to be understood as being modified by the term “about.”

### INCORPORATION BY REFERENCE

Examples of modules and transitions are described in, for example, US Patent Publication No. 2019/0087965, published on Mar. 21, 2019, titled Automatically Classifying Animal Behavior, which is incorporated by reference herein in its entirety.

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

### Overview

The inventors have developed systems and methods for automatically manipulating images of animals to a reference size and shape (e.g. normalizing them). Accordingly, the size matched or normalized images may then be processed with a behavioral recognition algorithm to tag the various behaviors. The size matching process allows the behavioral recognition algorithm to be trained with the same size of animals, so that the peculiarities of a given animal's shape does not impact the behavioral matching process.

Without size matching the mice, generally, a different algorithm would need to be trained for different size of mice. Accordingly, application of behavioral recognition algorithms would be difficult and limited to only mice that were all the same size, and make the training process for each new algorithm required to be trained on many different sets of mice. This would be extraordinarily time consuming. Additionally, the accuracy of the behavioral recognition algorithm on mice that are close to the same size (and thus wouldn't need a separately trained algorithm) may be improved, because the size matching could be applied to every mouse later processed using behavioral recognition algorithms.

Thus, after the images are processed for size matching, systems and methods are disclosed for automatically and objectively identifying and classifying behavioral modules of animals by processing images of the animals. These systems may classify animal behavioral state by quantitative measurement, processing, and analysis of an animal posture or posture trajectory in three-dimensions using a depth camera. These systems and methods obviate the need for a priori definition for what should constitute a measurable unit of action, thus making the classification of behavioral states objective and unsupervised.

In one aspect, the invention relates to a method for analyzing the motion of a subject to separate it into sub-second modules, the method comprising: (i) processing three-dimensional images that represent the motion of the subject using a computational model to partition the images into at least one set of sub-second modules and at least one set of transition periods between the sub-second modules; and (ii) assigning the at least one set of sub-second modules to a category that represents a type of animal behavior.

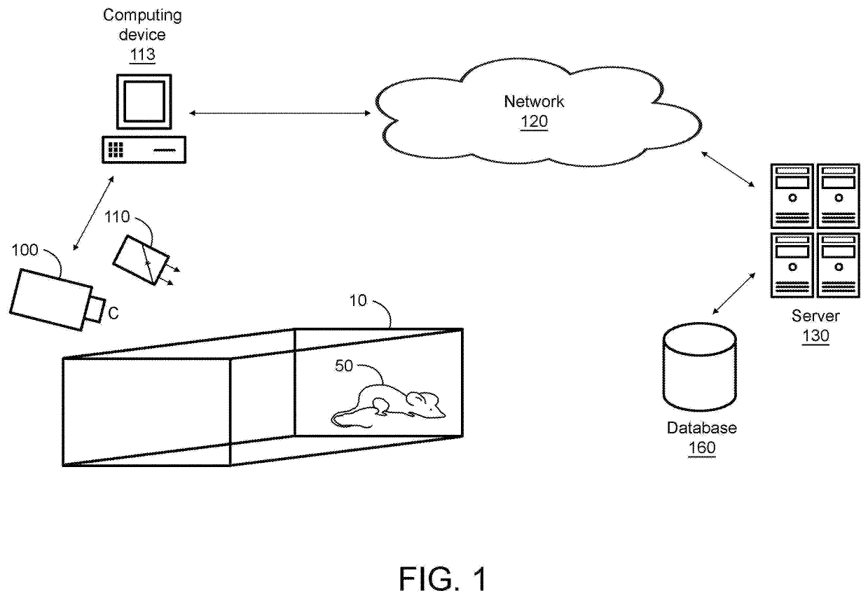

FIG. 1 illustrates an embodiment of the process a system may utilize to automatically classify image frames or sets of frames into behavioral modules. For instance, the system may include a camera 100 and tracking system 110. In some embodiments, camera 100 may be a three-dimensional depth camera and the tracking system 110 may project structured infrared light into the experimental field 110. Infrared receivers on the tracking system may be able to determine the location of an object based on parallax. In some embodiments, the camera 100 may be connected to the tracking system 110 or in some embodiments they may be separate components.

The camera 100 may output data related to video images and or tracking data from the tracking system 110 to a computing device 113. In some embodiments, the computing device 113 will perform pre-processing of the data locally before sending over a network 120 to be analyzed by a server 130 and to be saved in a database 160. In other embodiments, the data may be processed, and fit locally on a computing device 113.

In one embodiment, a three-dimensional depth camera 100 is used to obtain a stream of images of the animal 150 having both area and depth information. In another embodiment, 3D images are generated by imputation of one or more two-dimensional depth cameras 100. The background image (the empty experimental area) is then removed from each of the plurality of images to generate processed images having light and dark areas. The contours of the light areas in the plurality of processed images can be found and parameters from both area and depth image information within the contours can then be extracted to form a plurality of multi-dimensional data points, each data point representing the posture of the animal at a specific time. The posture data points can then be clustered so that point clusters represent animal behaviors.

Then, the pre-processed depth camera images may be input into the various models in order to classify the images into sub-second “modules” and transition periods that describe repeated units of behavior that are assembled together to form coherent behaviors observable by the human eye. The output of the models that classify the video data into modules may output several key parameters including: (1) the number of behavioral modules observed within a given set of experimental data (i.e. the number of states), (2) the parameters that describe the pattern of motion expressed by the mouse associated with any given module (i.e. state-specific autoregressive dynamical parameters), (3) the parameters that describe how often any particular module transitions to any other module (i.e. the state transition matrix), and (4) for each video frame an assignment of that frame to a behavioral module (i.e. a state sequence associated with each data sequence). In some embodiments, these latent variables were defined by a generative probabilistic process and were simultaneously estimated using Bayesian inference algorithms.

### Systems for Standardizing the Size and Shape of Organisms

In one aspect, provided herein is a system for standardizing the size and shape of organisms. The system provided herein can be useful in determining a number of phenotypes associated with experimental laboratory organisms (e.g., rodents).

The system provided herein can further comprise a housing for the organism or subject provided herein. The system provided herein can further comprise a housing for the camera provided herein. It is contemplated herein that the housing can protect the elements of the system (e.g., camera) from damage, elements, liquids, noise, and/or vibrations.

The housing can be any shape or dimensions suitable for the elements of the system and/or the size of the organism being studied.

The housing can be made of any material known in the art that is suitable for the care and use of a laboratory organism or animal. See e.g., Guide for the Care and Use of Laboratory Animals, 8th edition. Washington (DC): National Academies Press (US); 2011. ISBN-13: 978-0-309-15400-0ISBN-10: 0-309-15400-6, which is incorporated by reference in its entirety. Exemplary materials that can be used for the housing include but are not limited to: biocompatible materials, polymers, acrylic, glass, metal, silicon, polyurethanes or derivatives thereof, rubber, molded plastic, polymethylmethacrylate (PMMA), polycarbonate, polytetrafluoroethylene (TEFLON™), polyvinylchloride (PVC), polydimethylsiloxane (PDMS), polystyrene, dextrins, dextrans, polystyrene sulfonic acid, polysulfone, agarose, cellulose acetates, gelatin, alginate, iron oxide, stainless steel, gold, copper, silver chloride, polyethylene, acrylonitrile butadiene styrene (ABS), cyclo-olefin polymers (COP, e.g., ZEONOR®), or cyclo-olefin copolymers (COC, e.g., 1,2,3,4,4a,5,8,8a-octahydro-1,4:5,8-dimethanonaphthalene(tetracyclododecene) with ethene (such as TOPAS® Advanced Polymer's TOPAS, Mitsui Chemical's APEL).

In some embodiments, the system comprises one or more housing units. In some embodiments, the housing comprises one or more compartments for the organism. See e.g., Makowska et al. Scientific Reports 9, Article number 6179 (2019), which is incorporated herein by reference in its entirety. In some embodiments, the housing comprises food, water, light, nesting materials, levers, and environmental features (e.g, accessibility to a specific compartment within the housing, sounds, environmental triggers, pharmaceuticals).

The system provided herein can comprise a camera configured to output images of the organism.

### Camera Setup and Initialization

Various methods may be utilized to record and track images of animals 50 (e.g., mice). In some embodiments, the images recorded may be recorded in three-dimensions (e.g., X, Y, and Z axes). Various apparatuses are available for this function, for instance the experiments disclosed herein utilized Microsoft's Kinect for Windows. In other embodiments, the following additional apparatuses may be utilized: (1) stereo-vision cameras (which may include groups of two or more two-dimensional cameras calibrated to produce a depth image, (2) time-of-flight depth cameras (e.g. CamCube, PrimeSense, Microsoft Kinect 2, structured illumination depth cameras (e.g. Microsoft Kinect 1), and (3) x-ray video.

The camera 100 and tracking system 110 may project structured infrared light onto the imaging field 10, and compute the three-dimensional position of objects in the imaging field 10 upon parallax (FIG. 1). The Microsoft Kinect for Windows has a minimum working distance (in Near Mode) of 0.5 meters; by quantitating the number of missing depth pixels within an imaged field, the optimal sensor position may be determined. For example, the inventors have discovered that the optimal sensor position for a Kinect is between 0.6 and 0.75 meters away from the experimental field depending on ambient light conditions and assay material.

### Data Acquisition

Data output from the camera 100 and tracking system 110 may be received by and processed by a computing device 113 that processes the depth frames and saves them in a suitable format (e.g., binary or other format). In some embodiments, the data from the camera 100 and tracking system 110 may be directly output over a network 120 to a server 130, or may be temporarily buffered and/or sent over a USB or other connection to an associated computing device 113 that temporarily stores the data before sending over a network 120 to a centralized server 130 for further processing. In other embodiments, the data may be processed by an associated computer 113 without sending over a network 120 (FIG. 1).

For instance, in some embodiments, data output from a Kinect may be sent to a computer over a USB port utilizing custom Matlab® or other software to interface the Kinect via the official Microsoft® .NET API that retrieves depth frames at a rate of 30 frames per second and saves them in raw binary format (16-bit signed integers) to an external hard-drive or other storage device. Because USB3.0 has sufficient bandwidth to allow streaming of the data to an external hard-drive or computing device with storage in real-time. However, in some embodiments, a network may not have sufficient bandwidth to remotely stream the data in real time.

### Data Pre-Processing

In some embodiments, after the raw images of the image data are saved, various pre-processing may take place to isolate the animal in the image data and orient the images of the animal along a common axis for further processing. In some embodiments, the orientation of the head, nose, and/or extremities of the organism may be utilized to orient the images in a common direction. In other embodiments, an inferred direction of the spine may be incorporated.

For instance, tracking the evolution of an imaged mouse's pose over time requires identifying the mouse within a given video sequence, segmenting the mouse from the background (in this case the apparatus the mouse is exploring), orienting the isolated image of the mouse along the axis of its spine, correcting the image for perspective distortions, and then compressing the image for processing by the model.

In order to properly orient the mouse, various machine learning algorithms may be trained (e.g. a random forest classifier) on a set of manually-oriented extracted mouse images. Given an image, the orientation algorithm then returns an output indicating whether the mouse's nose and/or head is oriented correctly or not.

Once the position is identified, additional information may be extracted from the video data including the centroid, head and tail positions of the animal, orientation, length, width, height, and each of their first derivatives with respect to time. Characterization of the animal's pose dynamics required correction of perspective distortion in the X and Y axes. This distortion may be corrected by first generating a tuple of (x, y, z) coordinates for each pixel in real-world coordinates, and then resampling those coordinates to fall on an even grid in the (x, y) plane using Delaunay triangulation.

The images and videos acquired by the camera can be pre-processed prior to being submitted to the data processing network by smoothing the frames or images across time to remove sensor noise that is uncorrelated from frame to frame (e.g., median and mean). Furthermore, videos or images can be smoothed across space to correct for noise that is uncorrelated across space between frames or images. Smoothing of the images or frames from a video captured by the camera include, e.g., spatial, temporal, or spatiotemporal domains. Filters known in the art include but are not limited to, e.g., median, mean, and bilateral filters. Specifically, filters that can be applied to the images or frames acquired from the camera can include, but are not limited to, e.g., Gaussian and/or Median filters. Methods of applying image processing filters are known in the art and can be applied via image processing and analysis software, e.g., ImageJ®, MATLAB®, and/or Python®.

### Data Processing

The system provided herein comprises a control system comprising: one or more processors coupled to the memory. The control system provided herein can be configured to execute the machine executable code to (1) receive a set of images of the subject from the camera; and (2) process the set of images (e.g., 3-dimensional images) with a model to normalize them to a reference size and shape to output a set of normalized images.

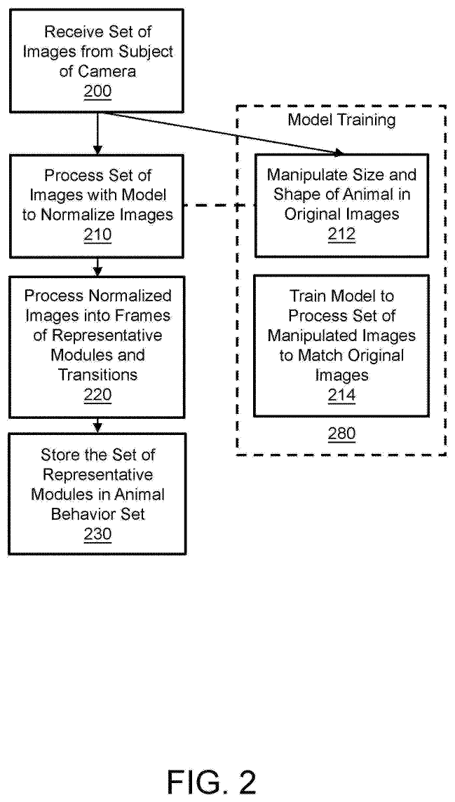

FIG. 2 illustrates an embodiment of a process the system may perform to normalize images from camera 100 using a mode after receiving a set of images output from a camera 200. In some examples, after the images are normalized they may be classified into behaviors (e.g., into behavioral modules and transitions (US Patent Publication No. 2019/0087965 which is incorporated herein by reference in its entirety) and stored in a behavioral set. In some embodiments, after the pre-processing is completed, processing a set of images 210 may take place after the images have been received from the camera 200 using the control system.

### Training

The system provided herein comprises a model to normalize the set of processed images to a reference size and shape to output a set of normalized images.

The normalizing model may be a deep neural network and may be trained 280 to normalize the images (FIG. 2). In some embodiments, the normalizing model may be an autoencoder, a convolutional autoencoder, a denoising convolutional autoencoder, a densenet, a generative adversarial network (GAN), a fully convolutional network (FCN) or a U-NET. In some embodiments, the deep neural network comprises a denoising convolutional autoencoder and a UNET.

For instance, the normalizing model may be first trained utilizing a reference size of animal, altering the images by manipulating their size and shape, and then training the model (e.g. a deep neural network) to restore the images to the original size and shape from the manipulated set. Particularly, the size and shape of an animal in a reference set of training images may be manipulated by changing the size and shape of the organism in the images, which may include altering the position, rotation, length, width, height, and aspect ratio of the organism.

Next, the model may then be trained to process the manipulated set of images to restore them to original size 214 in the reference set of training images (FIG. 2). Thus, the model may be trained on a variety of manipulated images to return them to the original size of the organism. In some examples, the organism may be a mouse and the model may be trained while a mouse is engaging in a variety of behaviors, and with a variety of different changes (e.g. one set of an image of the animal/mouse may be made larger, another training set may have the image of the mouse decreased in size, etc.).

In some embodiments, after the images have been processed with a model to normalize the images 210, the normalized images may be processed into frames of representative modules and transitions 220 or otherwise classified into behaviors. The set of normalized images may be processed using a computational model that may partition the frames into at least one set of frames that represent modules and at least one set of frames that may represent transitions between the modules. The frames that represent at least one set of modules may reference a data identifier. The data identifier may represent a type of animal behavior. The system may store the set of representative modules in an animal behavior set 230.

Random noise can be added to the depth value of each pixel to simulate sensor noise. As a pre-processing step, frames can be clustered into separate poses using an unsupervised algorithm (e.g., k-Means or a Gaussian Mixture Model). Then, the same number of frames are used per pose to ensure that the network does not over-or-under represent any particular configuration of the subject's body. For optimizing the weights of the network, any common optimization technique for neural networks (e.g., stochastic gradient descent) can be used. Finally, to train the network to remove any object that might occlude parts of the subject (e.g., a cable), the pixels of the image can be zeroed out using the shape of common occluders.

### Computer & Hardware Implementation of Disclosure

It should initially be understood that the disclosure herein may be implemented with any type of hardware and/or software, and may be a pre-programmed general purpose computing device. For example, the system may be implemented using a server, a personal computer, a portable computer, a thin client, or any suitable device or devices. The disclosure and/or components thereof may be a single device at a single location, or multiple devices at a single, or multiple, locations that are connected together using any appropriate communication protocols over any communication medium such as electric cable, fiber optic cable, or in a wireless manner.

It should also be noted that the disclosure is illustrated and discussed herein as having a plurality of modules which perform particular functions. It should be understood that these modules are merely schematically illustrated based on their function for clarity purposes only, and do not necessary represent specific hardware or software. In this regard, these modules may be hardware and/or software implemented to substantially perform the particular functions discussed. Moreover, the modules may be combined together within the disclosure, or divided into additional modules based on the particular function desired. Thus, the disclosure should not be construed to limit the present invention, but merely be understood to illustrate one example implementation thereof.

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., a HTML page) to a client device (e.g., for purposes of displaying data to and receiving user input from a user interacting with the client device). Data generated at the client device (e.g., a result of the user interaction) can be received from the client device at the server.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a “data processing apparatus” on data stored on one or more computer-readable storage devices or received from other sources.

The term “data processing apparatus” encompasses all kinds of apparatuses, devices, and machines for processing data, including by way of example a programmable processor, a computer, a system on a chip, or multiple ones, or combinations, of the foregoing. The apparatus can include special purpose logic circuitry, e.g., a FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

### Subjects, Behavioral Models, and Applications

The system provided herein is useful in the behavioral analysis of various organisms and animals known in the art. As discussed above, the set of three-dimensional images are normalized with a model with a reference size and shape.

The reference size and shape can be determined from a reference image or a pre-selected set of parameters. The reference image can be an image that was acquired by the system camera provided herein or an image that has already been processed. In some embodiments, the reference image or reference size/shape are computed from an organism at an earlier time point using the system and methods provided herein. In some embodiments, the reference image provided is an image of a normal, otherwise unaffected organism, animal, or population thereof (e.g., an organism that does not have a disease, an organism that does not have a genetic mutation or any gene editing, and organism that has not been administered a drug or an agent that may alter the physiology of the organism, an organism that has not undergone surgery, an organism that has not been an organism that has not been exposed to a particular environmental stimulus, a population of organisms that have not been affected by a given environmental stressor). The reference size and shape computed from the reference image can be compared with test images (e.g., an experimental organism) and used in training. The reference size can be determined by one of skill in the art based upon experimental need. By way of example only, the reference size can be obtained from a young adult male mouse model at approximately 8 to 12 weeks of age, as the male mouse is a commonly used biomedical research animal.

In some embodiments, the subject provided herein is a vertebrate. In some embodiments, the subject provided herein is a mammal. In some embodiments, the subject provided herein is an experimental animal or animal substitute as a disease model.

In some embodiments, the subject provided herein is a human. In some embodiments, the subject is a non-human primate.

In some embodiments, the subject provided herein is a rodent. In some embodiments, the subject provided herein is a mouse or a rat. In some embodiments, the mouse is a Mus musculus. In some embodiments, the mouse is a transgenic mouse or a mutant mouse. In some embodiments, the rat is a Rattus norvegicus domestica.

In some embodiments, the subject provided herein is an insect. In some embodiments, the insect is a fly. In some embodiments, the fly is a Drosophila melanogaster.

In some embodiments, the subject provided herein is a worm. In some embodiments, the subject provided herein is a C. elegans.

In some embodiments, the subject provided herein is a bird. In some embodiments, the bird is a Gallus gallus domesticus or Anas platyrhynchos.

In some embodiments, the subject provided herein is an aquatic animal. In some embodiments, the subject provided herein is a fish. In some embodiments, the subject provided herein is a zebrafish (Danio rerio).

In some embodiments of any of the aspects, the subject is being monitored for a type of animal behavior. In some embodiments of any of the aspects, the subject is being monitored for a disease phenotype.

The system provided herein can be useful for a number of applications in behavioral neuroscience, pathophysiology, physiology, psychology, social sciences, exercise, and nutrition. Examples of behavioral models and tests are known in the art and described e.g., in Nelson et al. Model Behavior: Animal experiments, complexity, and the genetics of psychiatric disorders, ISBN: 9780226546087, (20180; Gewirtz and Kim, Animal Models of Behavior Genetics (2016); Levin and Buccafusco. Animal Models of Cognitive Impairment. CRC Press. ISBN-13: 978-0367390679, ISBN-10: 0367390671 (2006); Garrett and Hough, Brain & Behavior 5^{th} edition, ISBN-13: 978-1506349206, ISBN-10: 9781506349206 (2017); Belovicova et al. Animal tests for anxiety-like and depression-like behavior in rats. Interdiscip. Toxicology 10(1) 40-43. (2017); Wolf et al. A comprehensive behavioral test battery to assess learning and memory in 129/Tg2576 mice. Plos One, (2016); and Breedlove et al. Behavioral Neuroscience ISBN-13:978-1605359076, ISBN-10:1605359076, (2019), which are incorporated herein by reference in their entireties.

The system provided herein can be used to evaluate the gait of a subject's movement, the detection of a disease, the analysis for drug or gene therapy screening, the analysis of a disease study including early detection of the onset of a disease, toxicology research, side-effect study, learning and memory process study, depression study, anxiety study, addiction study, nutrition study, and the analysis of consumer behavior. In particular, behavioral data using the system and methods provided herein can include but is not limited to: sniffing, rearing, investigating, walking, freezing, licking, eating, lever pressing, mating, hiding, burying, swimming, the absence or presence of an epileptic seizure, time spent in a particular section of the system (e.g., a compartment of the organism housing), latency, jumping, motivation, sensory capacity, preferences, habituation, time spent moving, time spent sleeping, time spent in the dark, time spent in the light, body temperature, change in body temperature, immobility time, immobility latency, distance traveled by the organism, response time, spatial acquisition, cued learning, time in target quadrant, time in annulus, and the number of errors made in a cognitive test or a maze.

In some aspects, provided herein is a system for the detection of a behavioral abnormality in a subject, the system comprising: a camera configured to output images of a subject; a memory in communication with the camera containing machine readable medium comprising machine executable code having stored thereon; a control system comprising one or more processors coupled to the memory, the control system configured to execute the machine executable code to cause the control system to: (i) receive a set of images of the subject from the camera; and (ii) process the set of three-dimensional images with a model to normalize them to a reference size and shape to output a set of normalized images.

In some aspects, provided herein is a system for the detection of a disease or disorder in a subject, the system comprising: a camera configured to output images of a subject; a memory in communication with the camera containing machine readable medium comprising machine executable code having stored thereon; a control system comprising one or more processors coupled to the memory, the control system configured to execute the machine executable code to cause the control system to: (i) receive a set of images of the subject from the camera; and (ii) process the set of three-dimensional images with a model to normalize them to a reference size and shape to output a set of normalized images.

In some aspects, provided herein is a system for the detection of a drug side-effect in a subject, the system comprising: a camera configured to output images of a subject; a memory in communication with the camera containing machine readable medium comprising machine executable code having stored thereon; a control system comprising one or more processors coupled to the memory, the control system configured to execute the machine executable code to cause the control system to: (i) receive a set of images of the subject from the camera; and (ii) process the set of three-dimensional images with a model to normalize them to a reference size and shape to output a set of normalized images.

In some aspects, provided herein is a system for the detection of a learning disability in a subject, the system comprising: a camera configured to output images of a subject; a memory in communication with the camera containing machine readable medium comprising machine executable code having stored thereon; a control system comprising one or more processors coupled to the memory, the control system configured to execute the machine executable code to cause the control system to: (i) receive a set of images of the subject from the camera; and (ii) process the set of three-dimensional images with a model to normalize them to a reference size and shape to output a set of normalized images.

In some aspects, provided herein is a system for the detection of depression and/or anxiety in a subject, the system comprising: a camera configured to output images of a subject; a memory in communication with the camera containing machine readable medium comprising machine executable code having stored thereon; a control system comprising one or more processors coupled to the memory, the control system configured to execute the machine executable code to cause the control system to: (i) receive a set of images of the subject from the camera; and (ii) process the set of three-dimensional images with a model to normalize them to a reference size and shape to output a set of normalized images.

In some aspects, provided herein is a system for the detection of an addiction in a subject, the system comprising: a camera configured to output images of a subject; a memory in communication with the camera containing machine readable medium comprising machine executable code having stored thereon; a control system comprising one or more processors coupled to the memory, the control system configured to execute the machine executable code to cause the control system to: (i) receive a set of images of the subject from the camera; and (ii) process the set of three-dimensional images with a model to normalize them to a reference size and shape to output a set of normalized images.

### Some Selected Definitions:

For convenience, certain terms employed in the entire application (including the specification, examples, and appended claims) are collected here. Unless defined otherwise, all technical and scientific terms used herein have the same meaning as commonly understood by one of ordinary skill in the art to which this invention belongs.

As used herein, the term “standardizing” or “standardization” refers to the general process of making two or more systems have identical sensitivities. This is accomplished in a two-step process, comprising normalization and drift correction. For example, this can be achieved by (1) manipulating the size and shape (includes altering the position, rotation, length, width, height, and aspect ratio of the organism in the frame or images); and (2) adding noise to the depth pixels to account for low-signal-to-noise imaging conditions. The overall resulting output is a restored set of images wherein the training subject is the original size and shape from the set of training images.

As used herein, “normalization” or “normalizing” refers to the process of making two or more elements of a system provide identical results at a particular point in time.

As used herein, “drift correction” refers to the process of making each individual element of the system insensitive to variation over time and/or environmental conditions.

As used herein, a “subject” means an organism, human, or animal. The term “non-human animals” and “non-human mammals” are used interchangeably herein and includes all vertebrates, e.g., mammals, such as non-human primates, (particularly higher primates), sheep, dog, rodent (e.g., mouse or rat), guinea pig, goat, pig, cat, rabbits, cows, and non-mammals such as chickens, amphibians, reptiles etc. Usually the animal is a vertebrate such as a primate, rodent, domestic animal, bird, or game animal.

As used herein, the terms “disease” or “disorder” refers to a disease, syndrome, or disorder, partially or completely, directly or indirectly, caused by one or more abnormalities in the genome, physiology, or behavior, or health of a subject. In some embodiments, the disease or disorder can be a neurological disease, a neurodegenerative disease, a neurodevelopmental disease or disorder, or a cognitive impairment.

The terms “decrease”, “reduced”, or “reduction”, are all used herein to mean a decrease by a statistically significant amount. In some embodiments, “reduce,” “reduction” or “decrease” typically means a decrease by at least 10% as compared to a reference level.

The terms “increased”, “increase”, or “enhance”, are all used herein to mean an increase by a statically significant amount. In some embodiments, the terms “increased”, “increase”, or “enhance”, can mean an increase of at least 10% as compared to a reference level.

As used herein, a “reference level” refers to a normal, otherwise unaffected subject (e.g., a control animal), image size, or dimensions of a particular shape within an image or set of images (e.g., number of pixels).

The term “statistically significant” or “significantly” refers to statistical significance and generally means a two standard deviation (2SD) or greater difference.

As used herein the term “comprising” or “comprises” is used in reference to compositions, methods, and respective component(s) thereof, that are essential to the invention, yet open to the inclusion of unspecified elements, whether essential or not.

As used herein, the term “consisting essentially of” refers to those elements required for a given embodiment. The term permits the presence of additional elements that do not materially affect the basic and novel or functional characteristic(s) of that embodiment of the invention.

The term “consisting of” refers to compositions, methods, and respective components thereof as described herein, which are exclusive of any element not recited in that description of the embodiment.

Although methods and materials similar or equivalent to those described herein can be used in the practice or testing of this disclosure, suitable methods and materials are described below. The abbreviation, “e.g.” is derived from the Latin Exempli gratia, and is used herein to indicate a non-limiting example. Thus, the abbreviation “e.g.” is synonymous with the term “for example.”

In some embodiments, the terms “a” and “an” and “the” and similar references used in the context of describing a particular embodiment of the application (especially in the context of certain of the following claims) can be construed to cover both the singular and the plural.

Some embodiments of the invention provided herein can be defined according to any of the following numbered paragraphs:
1) An image processing system for standardizing the size and shape of organisms, the system comprising:
   a camera configured to output images of a subject;
   a memory in communication with the camera containing machine readable medium comprising machine executable code having stored thereon;
   a control system comprising one or more processors coupled to the memory, the control system configured to execute the machine executable code to cause the control system to:
      i. receive a set of images of the subject from the camera; and
      ii. process the set of three-dimensional images with a model to normalize them to a reference size and shape to output a set of normalized images.
2) The system of paragraph 1, wherein the camera is a three-dimensional camera and the set of images of the subject are depth images.
3) The system of any one of paragraphs 1-2, wherein the model is a deep neural network.
4) The system of paragraph 3, wherein the deep neural network was trained by first manipulating a size and shape of a training subject in a set of training images to output a manipulated set of training images and training the deep neural network to process the set of manipulated training images to the original matching image from the set of training images to output a restored set of images wherein the training subject is the original size and shape from the set of training images.
5) The system of paragraph 3, wherein the deep neural network comprises a denoising convolutional autoencoder and a U-NET.
6) The system of paragraph 4, wherein first manipulating the size and shape comprises altering the position, rotation, length, width, height, and aspect ratio the organism.
7) The system of any one of paragraphs 1-6, wherein the control system is further configured to:
   process the set of normalized images using a computational model to partition the frames into at least one set of frames that represent modules and at least one set frames that represent transitions between the modules; and
   storing, in a memory, the at least one set of frames that represent modules referenced to a data identifier that represents a type of animal behavior.
8) The system of paragraph 7, wherein the control system is further configured to:
pre-process, using the control system, the set of normalized images to isolate the subject from the background;
   identify, using the control system, an orientation of a feature of the subject on a set of frames of the video data with respect to a coordinate system common to each frame;
   modify, using the control system, the orientation of the subject in at least a subset of the set of frames so that the feature is oriented in the same direction with respect to the coordinate system to output a set of aligned frames; and
   process, using the control system, the set of aligned frames using a principal component analysis to output pose dynamics data for each frame of the set of aligned frames, wherein the pose dynamics data represents a pose of the subject for each aligned frame through principal component space.
9) A method for standardizing the size and shape of organisms comprising: receiving a set of images from a subject from a camera; and
processing the set of three-dimensional images with a model to normalize them to a reference size and shape to put a set of normalized images.
10) The method of paragraph 9, said camera comprises a three-dimensional camera and the set of images of the subject are depth images.
11) The method of any one of paragraphs 9-10, said model comprises a deep neural network.
12) The method of paragraph 11, said deep neural network trained by first manipulating a size and shape of a training subject in a set of training images to output a manipulated set of training images and training the deep neural network to process the set of manipulated training images to the original matching image from the set of training images to output a restored set of images wherein the training subject is the original size and shape from the set of training images.
13) The method of paragraph 11, said deep neural network further comprises a denoising convolutional autoencoder and a U-NET.
14) The method of paragraph 12, said first manipulating the size and shape comprises altering the position, rotation, length, width, height, and aspect ratio of the organism.
15) The method of any one of paragraphs 9-14, said processing further comprising:
   processing the set of normalized images using a computational model to partition the frames into at least one set of frames that represent modules and at least one set of frames that represent transitions between modules; and
   storing, in a memory, the at least one set of frames that represent modules referenced to a data identifier that represents a type of animal behavior.
16) The method of paragraph 15, said processing comprising:
   pre-processing the set of normalized images to isolate the subject from the background;
   identifying an orientation of a feature of the subject on a set of frames of the video data with respect to a coordinate system common to each frame;
   modifying the orientation of the subject in at least a subset of the set of frames so that the feature is oriented in the same direction with respect to the coordinate system to output a set of aligned frames; and
   processing the set of aligned frames using a principal component analysis to output pose dynamics data for each frame of the set of aligned frames, wherein the pose dynamics data represents a pose of the subject for each aligned frame through principal component space.
17) A non-transitory machine readable medium having stored thereon instructions for performing a method comprising machine executable code which when executed by at least one machine, causes the machine to:
receive a set of images of the subject from a camera; and
process the set of three-dimensional images with a model to normalize them to a reference size and shape to output a set of normalized images.
18) The machine readable medium of paragraph 17, wherein the camera is a three-dimensional camera and the set of images of the subject are depth images.
19) The machine readable medium of any one of paragraphs 17-18, wherein the model is a deep neural network.
20) The machine readable medium of paragraph 19, wherein the deep neural network was trained by first manipulating a size and shape of a training subject in a set of training images to output a manipulated set of training images and training the deep neural network to process the set of manipulated training images to the original matching image from the set of training images to output a restored set of images wherein the training subject is the original size and shape from the set of training images.
21) The machine readable medium of paragraph 19, wherein the deep neural network comprises a denoising convolutional autoencoder and a U-NET.
22) The machine readable medium of paragraph 20, wherein first manipulating the size and shape comprises altering the position, rotation, length, width, height, and aspect ratio the organism.
23) The machine readable medium of any one of paragraphs 17-22, wherein the control system is further configured to:
process the set of normalized images using a computational model to partition the frames into at least one set of frames that represent modules and at least one set frames that represent transitions between the modules; and
storing, in a memory, the at least one set of frames that represent modules referenced to a data identifier that represents a type of animal behavior.
24) The machine readable medium of paragraph 23, wherein the control system is further configured to:
   pre-process the set of normalized images to isolate the subject from the background;
   identify an orientation of a feature of the subject on a set of frames of the video data with respect to a coordinate system common to each frame;
   modify the orientation of the subject in at least a subset of the set of frames so that the feature is oriented in the same direction with respect to the coordinate system to output a set of aligned frames; and
   process the set of aligned frames using a principal component analysis to output pose dynamics data for each frame of the set of aligned frames, wherein the pose dynamics data represents a pose of the subject for each aligned frame through principal component space.

### REFERENCES

1 Fettiplace, R. & Fuchs, P. A. Mechanisms of hair cell tuning. Annual review of physiology 61, 809-834, (1999).

2 Fettiplace, R. & Kim, K. X. The Physiology of Mechanoelectrical Transduction Channels in Hearing. Physiological reviews 94, 951-986, (2014).

3 Gollisch, T. & Herz, A. M. V. Disentangling Sub-Millisecond Processes within an Auditory Transduction Chain. PLoS Biology 3, e8, (2005).

4 Kawasaki, M., Rose, G. & Heiligenberg, W. Temporal hyperacuity in single neurons of electric fish. Nature 336, 173-176, (1988).

5 Nemenman, I., Lewen, G. D., Bialek, W. & de Ruyter van Steveninck, R. R. Neural Coding of Natural Stimuli: Information at Sub-Millisecond Resolution. PLoS computational biology 4, e1000025, (2008).

6 Peters, A. J., Chen, S. X. & Komiyama, T. Emergence of reproducible spatiotemporal activity during motor learning. Nature 510, 263-267, (2014).

7 Ritzau-Jost, A., Delvendahl, I., Rings, A., Byczkowicz, N., Harada, H., Shigemoto, R., Hirrlinger, J Eilers, J. & Hallermann, S. Ultrafast Action Potentials Mediate Kilohertz Signaling at a Central Synapse. Neuron 84, 152-163, (2014).

8 Shenoy, K. V., Sahani, M. & Churchland, M. M. Cortical Control of Arm Movements: A Dynamical Systems Perspective. Annual review of neuroscience 36, 337-359, (2013).

9 Bargmann, C. I. Beyond the connectome: How neuromodulators shape neural circuits. BioEssays 34, 458-465, (2012).

### CONCLUSION

The various methods and techniques described above provide a number of ways to carry out the invention. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps, some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Certain embodiments of this application are described herein. Variations on those embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

Particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

All patents, patent applications, publications of patent applications, and other material, such as articles, books, specifications, publications, documents, things, and/or the like, referenced herein are hereby incorporated by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

### EXAMPLES

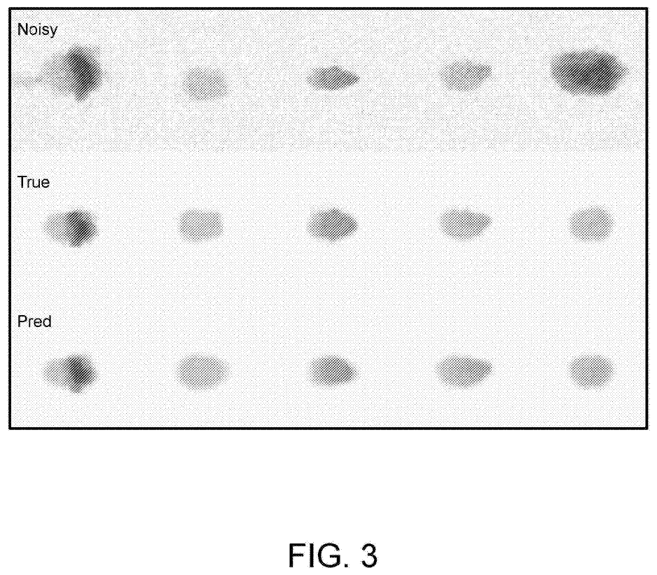

FIG. 3 illustrates example images utilized in the training of the disclosed models to normalize images to a reference size and shape. Particularly, the displayed set of images were used to train a deep neural network to reconstruct clean mouse images from corrupted or size and shape manipulated images. The top row of images shows the frames that have been manipulated, corrupted or noisy. The middle row shows images that original, clean frames from the training set and the bottom row show the reconstructed images after applying the model. The images were collected using a depth video camera where intensity indicated height from the floor.

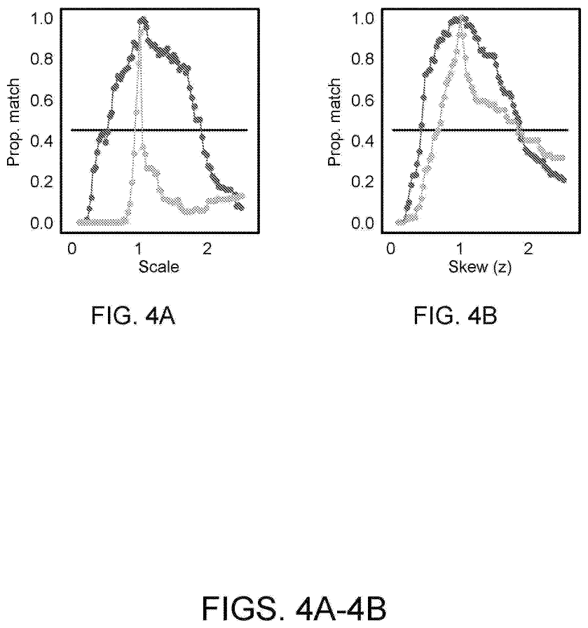

FIGS. 4A and 4B illustrate graphs showing an example of the comparative results of application of the disclosed normalizing models and subsequent behavioral classification. The behavioral models were first applied without normalization illustrated as the orange line, and then were applied after normalizing the images, the results of which are illustrated as the blue line. FIG. 4A illustrates the behavioral classification results when the images are varied in scale, and FIG. 4B illustrates the results when the images are varied in skew. Accordingly, the results indicate that the size and shape normalization models performed quite accurately, and allow much more robust classification of behavior irrespective of the size and shape of a particular organism.

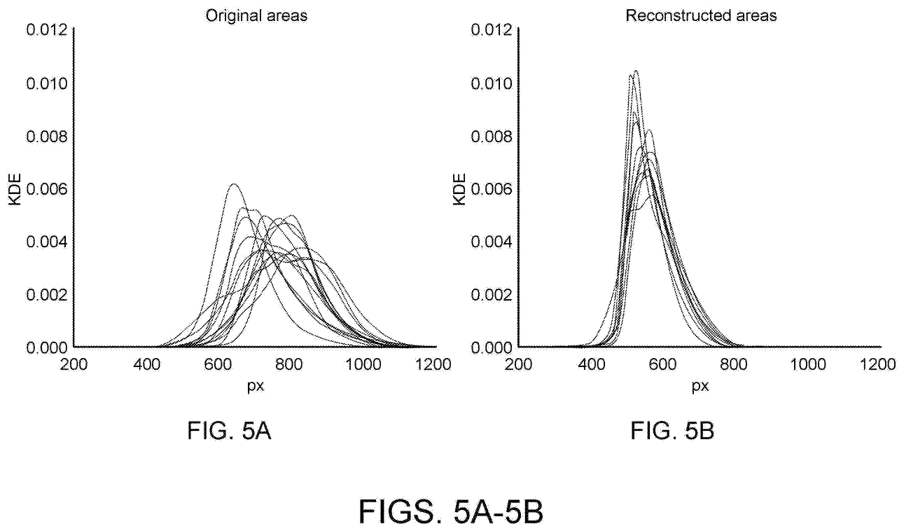

FIGS. 5A and 5B illustrate graphs showing the distribution of mouse shape before (FIG. 5A) and after (FIG. 5B) applying the normalization model. Each line refers to an individual mouse or animal. Accordingly, the disclosed models successfully size normalized the mouse in this example.

1. An image processing system for standardizing the size and shape of organisms, the system comprising:
a camera configured to output images of a subject;
a memory in communication with the camera containing machine readable medium comprising machine executable code having stored thereon;
a control system comprising one or more processors coupled to the memory, the control system configured to execute the machine executable code to cause the control system to:
receive a set of images of the subject from the camera; and
process the set of three-dimensional images with a model to normalize them to a reference size and shape to output a set of normalized images.

2. The system of claim 1, wherein the camera is a three-dimensional camera and the set of images of the subject are depth images.

3. The system of claim 1, wherein the model is a deep neural network.

4. The system of claim 3, wherein the deep neural network was trained by first manipulating a size and shape of a training subject in a set of training images to output a manipulated set of training images and training the deep neural network to process the set of manipulated training images to the original matching image from the set of training images to output a restored set of images wherein the training subject is the original size and shape from the set of training images.

5. The system of claim 3, wherein the deep neural network comprises a denoising convolutional autoencoder and a U-NET.

6. The system of claim 4, wherein first manipulating the size and shape comprises altering the position, rotation, length, width, height, and aspect ratio the organism.

7. The system of claim 1, wherein the control system is further configured to:
process the set of normalized images using a computational model to partition the frames into at least one set of frames that represent modules and at least one set frames that represent transitions between the modules; and
storing, in a memory, the at least one set of frames that represent modules referenced to a data identifier that represents a type of animal behavior.

8. The system of claim 7, wherein the control system is further configured to:
pre-process, using the control system, the set of normalized images to isolate the subject from the background;
identify, using the control system, an orientation of a feature of the subject on a set of frames of the video data with respect to a coordinate system common to each frame;
modify, using the control system, the orientation of the subject in at least a subset of the set of frames so that the feature is oriented in the same direction with respect to the coordinate system to output a set of aligned frames; and
process, using the control system, the set of aligned frames using a principal component analysis to output pose dynamics data for each frame of the set of aligned frames, wherein the pose dynamics data represents a pose of the subject for each aligned frame through principal component space.

9. A method for standardizing the size and shape of organisms comprising:
receiving a set of images from a subject from a camera; and
processing the set of three-dimensional images with a model to normalize them to a reference size and shape to put a set of normalized images.

10. The method of claim 9, said camera comprises a three-dimensional camera and the set of images of the subject are depth images.

11. The method of claim 9, said model comprises a deep neural network.

12. The method of claim 11, said deep neural network trained by first manipulating a size and shape of a training subject in a set of training images to output a manipulated set of training images and training the deep neural network to process the set of manipulated training images to the original matching image from the set of training images to output a restored set of images wherein the training subject is the original size and shape from the set of training images.

13. The method of claim 11, said deep neural network further comprises a denoising convolutional autoencoder and a U-NET.

14. The method of claim 12, said first manipulating the size and shape comprises altering the position, rotation, length, width, height, and aspect ratio of the organism.

15. The method of claim 9, said processing further comprising:
processing the set of normalized images using a computational model to partition the frames into at least one set of frames that represent modules and at least one set of frames that represent transitions between modules; and
storing, in a memory, the at least one set of frames that represent modules referenced to a data identifier that represents a type of animal behavior.

16. The method of claim 15, said processing comprising:
pre-processing the set of normalized images to isolate the subject from the background;
identifying an orientation of a feature of the subject on a set of frames of the video data with respect to a coordinate system common to each frame;
modifying the orientation of the subject in at least a subset of the set of frames so that the feature is oriented in the same direction with respect to the coordinate system to output a set of aligned frames; and
processing the set of aligned frames using a principal component analysis to output pose dynamics data for each frame of the set of aligned frames, wherein the pose dynamics data represents a pose of the subject for each aligned frame through principal component space.

17. A non-transitory machine readable medium having stored thereon instructions for performing a method comprising machine executable code which when executed by at least one machine, causes the machine to:
receive a set of images of the subject from a camera; and
process the set of three-dimensional images with a model to normalize them to a reference size and shape to output a set of normalized images.

18. The machine readable medium of claim 17, wherein the camera is a three-dimensional camera and the set of images of the subject are depth images.

19. The machine readable medium of claim 17, wherein the model is a deep neural network.

20. The machine readable medium of claim 19, wherein the deep neural network was trained by first manipulating a size and shape of a training subject in a set of training images to output a manipulated set of training images and training the deep neural network to process the set of manipulated training images to the original matching image from the set of training images to output a restored set of images wherein the training subject is the original size and shape from the set of training images.

21. The machine readable medium of claim 19, wherein the deep neural network comprises a denoising convolutional autoencoder and a U-NET.

22. The machine readable medium of claim 20, wherein first manipulating the size and shape comprises altering the position, rotation, length, width, height, and aspect ratio the organism.

23. The machine readable medium of claim 17, wherein the control system is further configured to:
process the set of normalized images using a computational model to partition the frames into at least one set of frames that represent modules and at least one set frames that represent transitions between the modules; and
storing, in a memory, the at least one set of frames that represent modules referenced to a data identifier that represents a type of animal behavior.

24. The machine readable medium of claim 23, wherein the control system is further configured to:
pre-process the set of normalized images to isolate the subject from the background;
identify an orientation of a feature of the subject on a set of frames of the video data with respect to a coordinate system common to each frame;
modify the orientation of the subject in at least a subset of the set of frames so that the feature is oriented in the same direction with respect to the coordinate system to output a set of aligned frames; and
process the set of aligned frames using a principal component analysis to output pose dynamics data for each frame of the set of aligned frames, wherein the pose dynamics data represents a pose of the subject for each aligned frame through principal component space.
